(19) United States
(12) Patent Application Publication
(10) Pub. No.: US 2026/0048599 A1
(43) Pub. Date: Feb. 19, 2026

(54) TABLE MOVING MECHANISM AND INKJET PRINTER INCLUDING THE SAME

(71) Applicant: Roland DG Corporation, Hamamatsu-shi (JP)

(72) Inventors: Kikuo MATSUBA, Hamamatsu-shi (JP); Naoki KOTOBUKI, Hamamatsu-shi (JP); Ryosuke KOBAYASHI, Hamamatsu-shi (JP)

(21) Appl. No.: 19/369,992

(22) Filed: Oct. 27, 2025

Related U.S. Application Data
(63) Continuation of application No. PCT/JP2024/000768, filed on Jan. 15, 2024.

(30) Foreign Application Priority Data
Apr. 28, 2023 (JP) 2023-074739

(51) Int. Cl. B41J 11/20; B41J 3/28; B41J 11/06; B41J 11/14; B41J 25/00

(52) U.S. Cl. CPC B41J 11/20; B41J 3/28; B41J 11/06; B41J 11/14; B41J 25/001

(57) ABSTRACT

A table moving mechanism includes a table, a slide apparatus including a first base and slide rails, and a lift including a vertical mover to raise and lower the first base. The table is moved in a first direction along the slide rails. The vertical mover raises and lowers the first base so as to move the table in an up-down direction. Because the vertical mover does not move in the first direction, the table moving mechanism needs no table carriage to move the vertical mover in the first direction. Consequently, the table moving mechanism is not required to have a dual-box shape necessary for conventional table moving mechanisms.

### CROSS REFERENCE TO RELATED APPLICATIONS

This application claims the benefit of priority to Japanese Patent Application No. 2023-074739 filed on Apr. 28, 2023 and is a Continuation Application of PCT Application No. PCT/JP2024/000768 filed on Jan. 15, 2024. The entire contents of each application are incorporated herein by reference.

### BACKGROUND OF THE INVENTION

### 1. Field of the Invention

The present invention relates to table moving mechanisms and inkjet printers including the table moving mechanisms.

### 2. Description of the Related Art

JP 2020-151996A, for example, discloses a table moving mechanism including a slide apparatus to move a table unit in a front-rear direction, and a raising and lowering apparatus to move the table unit in an up-down direction. The table unit includes a table on which a recording medium is to be placed. The table unit further includes a table carriage that houses the raising and lowering apparatus, including raising and lowering shafts and/or other component(s), and that includes an upward opening, and a raising and lowering case supporting the table on which the medium is to be placed. The raising and lowering case is inserted into the opening of the table carriage. The raising and lowering case is configured to be movable in the up-down direction relative to the table carriage. The slide apparatus moves the table carriage in the front-rear direction. The raising and lowering apparatus is housed in the table carriage and moves the raising and lowering case in the up-down direction. The table moving mechanism is thus able to move the recording medium in the front-rear direction and the up-down direction.

### SUMMARY OF THE INVENTION

In an inkjet printer disclosed in JP 2020-151996A, the raising and lowering apparatus to move the table unit in the up-down direction is mounted on the slide apparatus to move the table unit in the front-rear direction. Thus, the raising and lowering shafts and/or other component(s) to raise and lower the table unit are/is housed in the table carriage, and the raising and lowering case moves to protrude upward from the table carriage, making it possible to adjust the height of the raising and lowering case (or the table) relative to the slidable table carriage. To enable such adjustments, the table carriage has a box shape that is able to house the raising and lowering shafts and/or other component(s), and the raising and lowering case has a box shape in order to allow the table to move a predetermined distance. This results in the table moving mechanism having a dual-box shape formed by the table carriage and the raising and lowering case. Consequently, the table moving mechanism has a relatively large size. Because the table moving mechanism has a relatively large size, the inkjet printer including the table moving mechanism also has a relatively large size.

Accordingly, example embodiments of the present invention provide small-sized table moving mechanisms and inkjet printers including the small-sized table moving mechanisms.

A table moving mechanism according to an example embodiment of the present invention includes a table on which a recording medium is to be placed, a slide apparatus to convey the table in a first direction that is horizontal, and a lift to adjust a height of the table in an up-down direction, wherein the slide apparatus includes a slide rail supporting the table and extending in the first direction, a first base provided with the slide rail, and a conveyor to move the table in the first direction relative to the first base along the slide rail, and the lift includes raising and lowering shafts in engagement with the first base and extending in the up-down direction, a second base on which the raising and lowering shafts stand, and a vertical mover to move the first base relative to the second base in the up-down direction along the raising and lowering shafts.

In a table moving mechanism according to an example embodiment of the present invention, the table having the recording medium placed thereon is moved by the slide apparatus and the lift. The conveyor of the slide apparatus moves the table in the first direction relative to the first base along the slide rail. The vertical mover of the lift moves the first base in the up-down direction relative to the second base along the raising and lowering shafts. The movement of the first base in the up-down direction results in movement of the table in the up-down direction. In the table moving mechanism according to the present example embodiment, the first base supporting the table is moved in the up-down direction relative to the second base by the lift. Because the vertical mover included in the table moving mechanism according to the present example embodiment does not move in the first direction unlike vertical movers known in the related art, the table moving mechanism according to the present example embodiment needs no table carriage to move the vertical mover in the first direction, and the vertical mover is thus simply required to move the table itself (or the first base supporting the table) in the up-down direction. Accordingly, the table moving mechanism according to the present example embodiment is not required to have a dual-box shape. This consequently enables the table moving mechanism to be small in size.

Various example embodiments of the present invention provide small-sized table moving mechanisms and inkjet printers including the small-sized table moving mechanisms.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a printer according to a first example embodiment of the present invention.

FIG. 2 is a perspective view of the inside of the printer according to the first example embodiment of the present invention.

FIG. 3 is a schematic diagram illustrating an arrangement of components on a bottom surface of a head carriage according to the first example embodiment of the present invention.

FIG. 4 is a perspective view of a table according to the first example embodiment of the present invention.

FIG. 5 is a perspective view of a slide apparatus according to the first example embodiment of the present invention.

FIG. 6 is a schematic diagram illustrating an arrangement of components on a bottom surface of the slide apparatus according to the first example embodiment of the present invention.

FIG. 7 is a schematic diagram of a second base according to the first example embodiment as viewed from below.

FIG. 8 is a partial cross-sectional view of the vicinity of a holder.

FIG. 9 is a perspective view of a portion of a lift according to the first example embodiment and its vicinity.

FIG. 10 is a side view of a table moving mechanism according to the first example embodiment of the present invention.

FIG. 11 is a perspective view of the inside of a printer according to a second example embodiment of the present invention.

FIG. 12 is a perspective view of a portion of a lift according to the second example embodiment and its vicinity.

FIG. 13 is a partial cross-sectional view of the vicinity of a guiding jig according to the second example embodiment of the present invention.

FIG. 14 is a perspective view of the guiding jig.

FIG. 15 is a perspective view of an adjuster according to the second example embodiment of the present invention.

FIG. 16 is a plan view of the vicinity of the adjuster.

### DETAILED DESCRIPTION OF THE EXAMPLE EMBODIMENTS

Referring to the drawings, table moving mechanisms according to example embodiments of the present invention and inkjet printers (each of which will hereinafter be referred to as a “printer”) including the table moving mechanisms will be described below. The example embodiments described below are naturally not intended to limit the present invention in any way. Components and elements having the same functions will be identified by the same reference signs and will be described briefly or will not be described when deemed redundant.

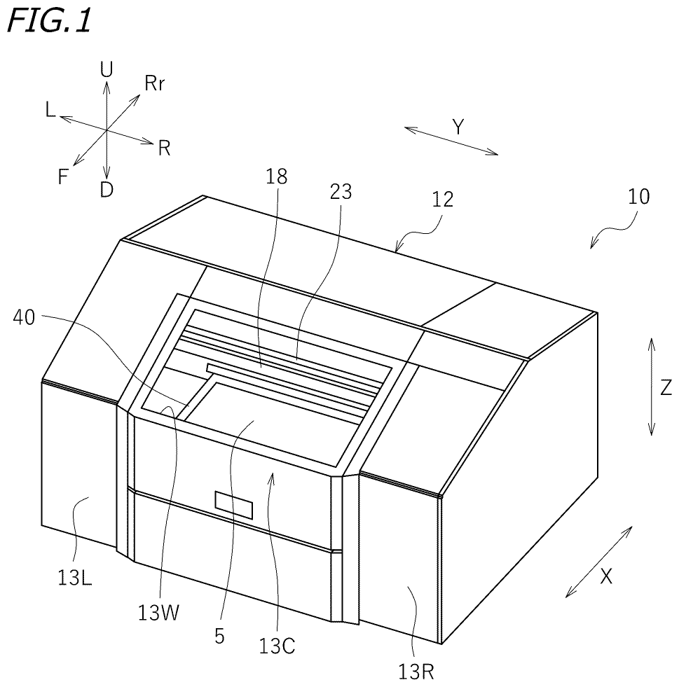

FIG. 1 is a perspective view of a printer 10 according to a first example embodiment of the present invention. In the following description, a direction away from the printer 10 and a direction toward the printer 10 when the printer 10 is viewed from the front are respectively defined as a forward direction and a rearward direction. Leftward, rightward, upward, and downward directions respectively represent leftward, rightward, upward, and downward directions when the printer 10 is viewed from the front. The reference signs F, Rr, L, R, U, and D in the drawings respectively represent forward, rearward, leftward, rightward, upward, and downward directions. The reference sign Y in the drawings represents a main scanning direction. In this example embodiment, the main scanning direction Y corresponds to a right-left direction. The main scanning direction Y is an example of a second direction. The reference sign X represents a sub-scanning direction. In this example embodiment, the sub-scanning direction X corresponds to a front-rear direction and is perpendicular or substantially perpendicular to the main scanning direction Y in a plan view. The sub-scanning direction X is an example of a first direction. The reference sign Z represents an up-down direction. These directions, however, are defined merely for the sake of convenience of description. These directions do not limit in any way how the printer 10 may be installed or how example embodiments of the present invention may be practiced.

The printer 10 is an inkjet printer. In the present example embodiment, the printer 10 moves a recording medium 5 in the front-rear direction and discharges ink from ink heads 34 mounted on an ink head unit 30 configured to move in the right-left direction. The printer 10 thus prints an image on the recording medium 5.

The recording medium 5 is, for example, recording paper. The recording medium 5, however, is not limited to recording paper. Examples of the recording medium 5 may include a sheet made of resin material(s), such as polyvinyl chloride (PVC) and/or polyester; and a relatively thick medium, such as a metallic plate (which is made of aluminum, iron, or other metallic material), a glass plate, or a wood plate. The recording medium 5 is an example of a workpiece. The recording medium 5 is an example of a medium.

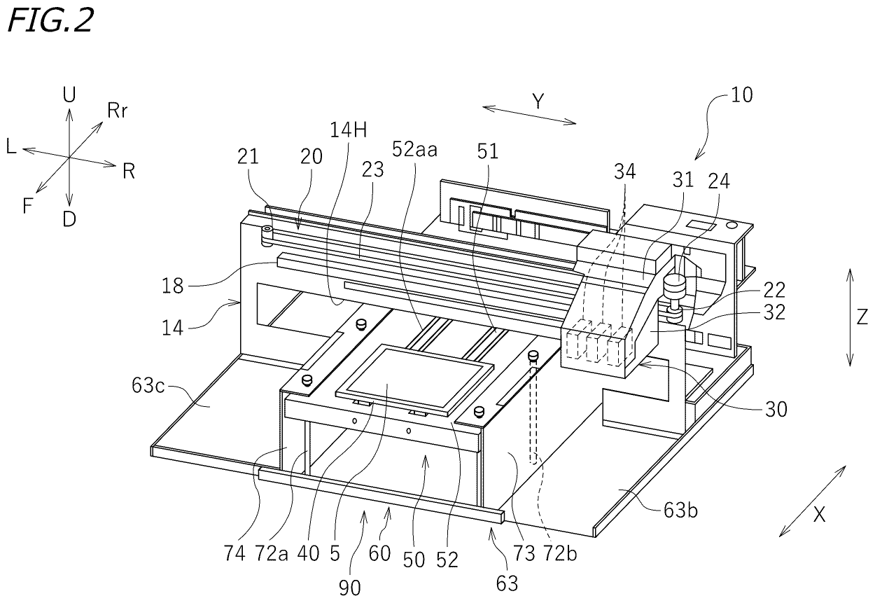

As illustrated in FIG. 2, the printer 10 includes a body case 12 (FIG. 1), a body frame 14, a carriage moving mechanism 20, the ink head unit 30, and a table moving mechanism 90. The table moving mechanism 90 includes a table 40, a slide apparatus 50, a lift 60, a first side wall 73, and a second side wall 74.

As illustrated in FIG. 1, the body case 12 is a box-shaped structure that defines a housing space to house the body frame 14, the carriage moving mechanism 20, the ink head unit 30, and other component(s) together with a second base 63 of the table moving mechanism 90 (which will be described below). A central front portion of the body case 12 is provided with a front cover 13C. A left front portion of the body case 12 is provided with a left cover 13L. A right front portion of the body case 12 is provided with a right cover 13R. The front cover 13C, the left cover 13L, and the right cover 13R are configured to be able to cover and uncover the housing space of the body case 12. The front cover 13C is provided with a window 13W. The window 13W is made of, for example, a transparent acrylic plate. An operator is able to visually check the inside of the body case 12 through the window 13W. As illustrated in FIG. 2, the ink head unit 30 is disposed above the table 40. The ink head unit 30 is disposed inside the body case 12 (see FIG. 1). The ink head unit 30 includes the ink heads 34, a case 31, and a head carriage 32 equipped with the ink heads 34. In FIG. 2, the body case 12 is not illustrated for the sake of convenience of description.

As illustrated in FIG. 2, the body frame 14 is a structure extending upward from the second base 63 (which will be described below) and extending in the main scanning direction Y. The body frame 14 is provided with an opening 14H defined therethrough in the sub-scanning direction X. The slide apparatus 50 is configured to pass through the opening 14H.

As illustrated in FIG. 2, the printer 10 includes a guide rail 18 provided on the body frame 14. The guide rail 18 is supported by the second base 63 (which will be described below) through the body frame 14. The guide rail 18 extends in the main scanning direction Y. The guide rail 18 is provided along a front surface of the body frame 14. The guide rail 18 is disposed above the opening 14H. The guide rail 18 is disposed above the table 40. The head carriage 32 of the ink head unit 30 is slidable along the guide rail 18. The guide rail 18 guides movement of the head carriage 32 in the main scanning direction Y. The case 31 is attached to the head carriage 32.

The carriage moving mechanism 20 moves the head carriage 32 in the main scanning direction Y relative to the recording medium 5 placed on the table 40. The carriage moving mechanism 20 is not limited to any particular configuration, structure, or arrangement. The carriage moving mechanism 20 includes a left pulley 21, a right pulley 22, a belt 23, and a head carriage motor 24. The left pulley 21 is disposed leftward relative to a left end of the guide rail 18. The right pulley 22 is disposed rightward relative to a right end of the guide rail 18. The belt 23 is wound around the pulleys 21 and 22. The head carriage motor 24 is connected to the right pulley 22. In this example embodiment, activation of the head carriage motor 24 rotates the pulley 22 so as to cause the belt 23 to run between the pulleys 21 and 22. Alternatively, the head carriage motor 24 may be connected to the left pulley 21. In this case, activation of the head carriage motor 24 rotates the pulley 21 so as to cause the belt 23 to run between the pulleys 21 and 22.

The head carriage 32 is attached to the belt 23. The head carriage 32 is connected to the guide rail 18 so as to be slidable along the guide rail 18. The head carriage 32 is disposed above the table 40. The head carriage 32 includes the ink heads 34. Activation of the head carriage motor 24 causes the belt 23 to run, with the result that the head carriage 32 moves in the main scanning direction Y. The movement of the head carriage 32 in the main scanning direction Y causes the ink heads 34, which are mounted on the head carriage 32, to move in the main scanning direction Y.

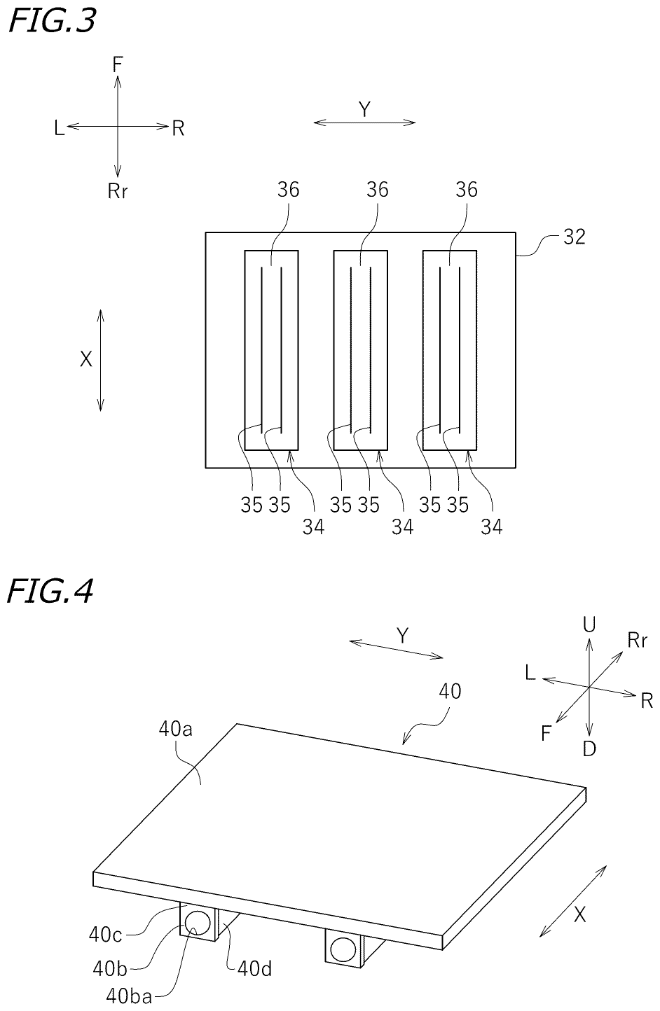

As illustrated in FIG. 3, the shape of each ink head 34 is such that each ink head 34 is longer in the sub-scanning direction X than in the main scanning direction Y. The ink heads 34 are similar in shape and size. The ink heads 34 each include nozzles 35 arranged in the sub-scanning direction X, and a nozzle surface 36 provided with the nozzles 35. The ink heads 34 are each provided with the nozzles 35 arranged in two nozzle rows. The nozzles 35 discharge ink onto the recording medium 5. The inside of each nozzle 35 is set at a negative pressure (i.e., a pressure lower than atmospheric pressure). Because the nozzles 35 are minute, the nozzles 35 arranged in the sub-scanning direction X are represented as straight lines in FIG. 3. In the present example embodiment, the number of ink heads 34 included in the ink head unit 30 is three. The number of ink heads 34, however, is not limited to three. In the present example embodiment, the ink heads 34 each include two nozzle rows. The number of nozzle rows included in each ink head 34, however, is not limited to two.

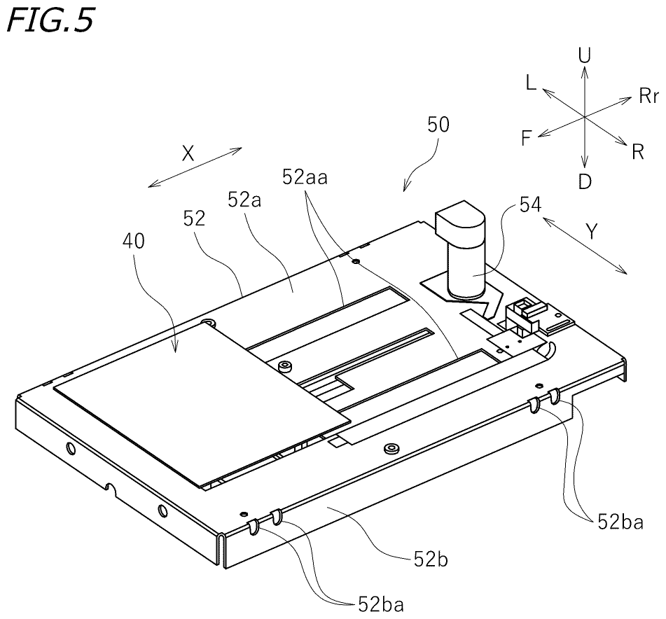

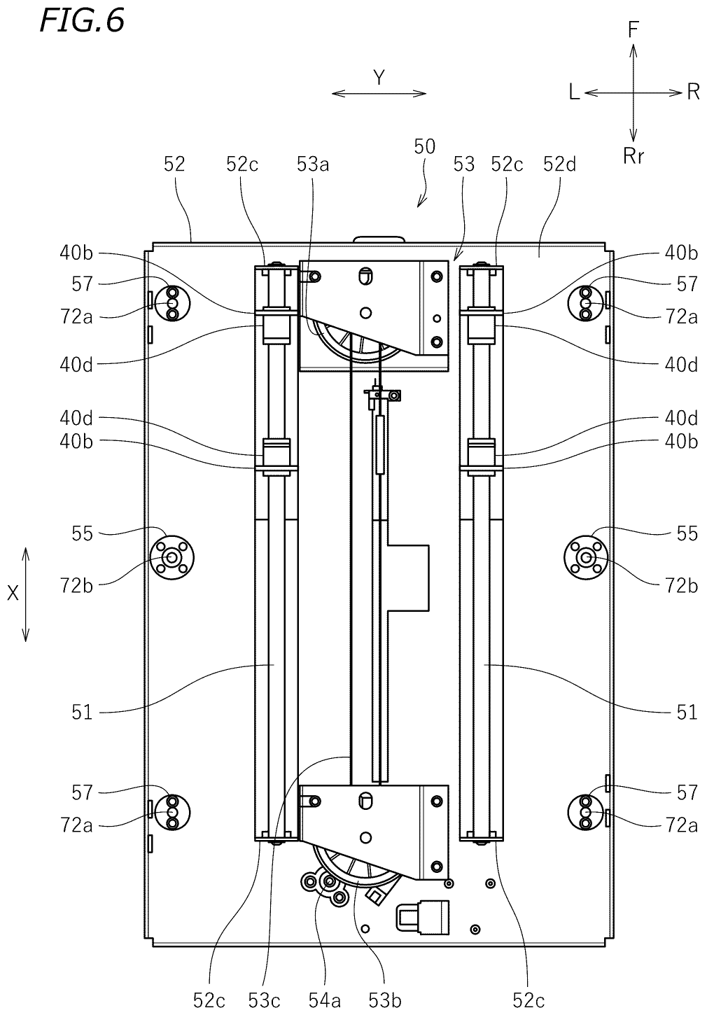

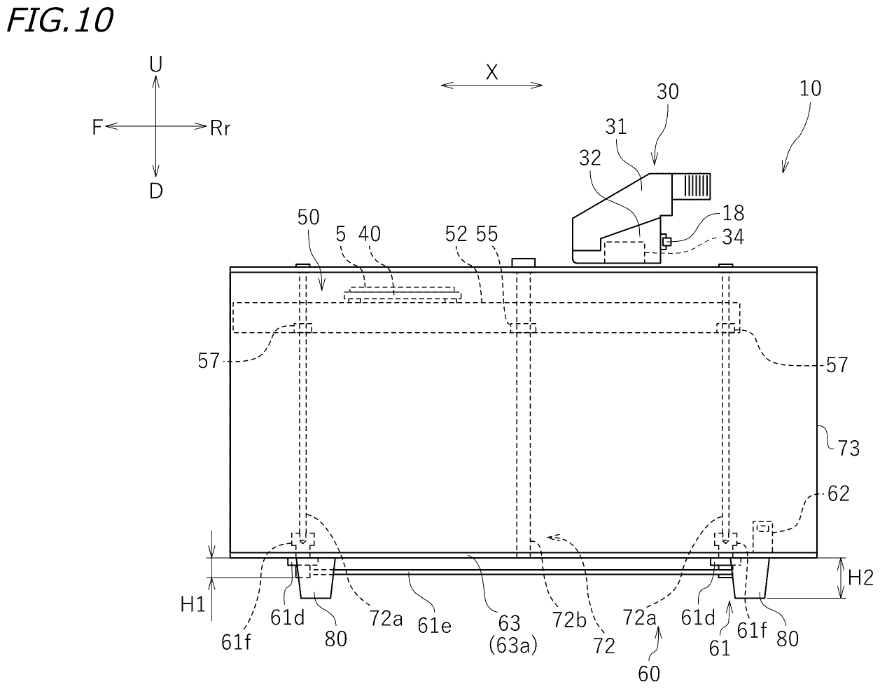

The slide apparatus 50 moves the table 40 (which is illustrated in FIG. 4) in the sub-scanning direction X as illustrated in FIG. 5. As illustrated in FIG. 6, the slide apparatus 50 includes slide rails 51 supporting the table 40 (see FIG. 4) such that the table 40 is movable along the slide rails 51, a first base 52 provided with the slide rails 51, a conveyor 53 to move the table 40 in the sub-scanning direction X, and a conveying motor 54 (see FIG. 5). As illustrated in FIG. 10, the lift 60 includes raising and lowering shafts 72, holders 57, nuts 56 (see FIG. 8), bushings 55, a vertical mover 61 to move the first base 52 in the up-down direction Z along the raising and lowering shafts 72, a raising and lowering motor 62 to actuate the vertical mover 61, and the second base 63 on which the raising and lowering shafts 72 stand.

As illustrated in FIG. 2, the recording medium 5 is placed on the table 40. The table 40 is displaced below the ink heads 34. As illustrated in FIG. 4, the table 40 includes a table body 40a, engaging portions 40b, connectors 40c, and ball bushings 40d. The table body 40a is a rectangular or substantially rectangular structure on which the recording medium 5 is to be placed. The table body 40a has a rectangular or substantially rectangular shape whose length is shorter in the sub-scanning direction X than in the main scanning direction Y. Alternatively, the table body 40a may have a rectangular or substantially rectangular shape whose length is longer in the sub-scanning direction X than in the main scanning direction Y. Optionally, the table body 40a may have a rectangular or substantially rectangular shape whose lengths in the sub-scanning direction X and the main scanning direction Y are equal to each other. The slide rails 51 (see FIG. 6) are inserted through the engaging portions 40b. In the present example embodiment, the engaging portions 40b are provided with holes 40ba defined therethrough in the sub-scanning direction X. The ball bushings 40d are also provided with holes (not illustrated) equal or substantially equal in diameter to the holes 40ba. The slide rails 51 are inserted through the holes 40ba of the engaging portions 40b and the holes of the ball bushings 40d, with the result that the table 40 is slidably supported by the slide rails 51. The engaging portions 40b are connected with the ball bushings 40d. The ball bushings 40d are disposed such that the ball bushings 40d are located closer to the center of the table body 40a in the front-rear direction than the engaging portions 40b. The connectors 40c connect the table body 40a to the engaging portions 40b. Specifically, the table body 40a is located above the connectors 40c, and the engaging portions 40b are located below the connectors 40c. As illustrated in FIG. 2, with the connectors 40c inserted in the through holes 52aa (which will be described below) in the up-down direction Z, the slide rails 51 are inserted through the engaging portions 40b. Accordingly, the table body 40a located above the connectors 40c is disposed above the through holes 52aa. The engaging portions 40b located below the connectors 40c are disposed below the through holes 52aa. In the present example embodiment, the number of engaging portions 40b is four in total, and the four engaging portions 40b are divided into two front engaging portions 40b arranged in the main scanning direction Y, and two rear engaging portions 40b arranged in the main scanning direction Y. The four engaging portions 40b are also divided into two right engaging portions 40b arranged in the sub-scanning direction X, and two left engaging portions 40b arranged in the sub-scanning direction X. In the present example embodiment, the number of connectors 40c is four in total, and the four connectors 40c are divided into two front connectors 40c arranged in the main scanning direction Y, and two rear connectors 40c arranged in the main scanning direction Y. The four connectors 40c are also divided into two right connectors 40c arranged in the sub-scanning direction X, and two left connectors 40c arranged in the sub-scanning direction X. Alternatively, any suitable number of engaging portions 40b may be disposed at any other suitable locations, and any suitable number of connectors 40c may be disposed at any other suitable locations.

The slide rails 51 extend in the sub-scanning direction X. In the present example embodiment, the slide rails 51 are disposed under an upper surface 52a of the first base 52 (which will be described below). As illustrated in FIG. 6, ends of each slide rail 51 are fixed to associated ones of fixtures 52c included in the first base 52 and extending downward therefrom. The slide rails 51 are slidably inserted through the engaging portions 40b and the ball bushings 40d. In the present example embodiment, the number of slide rails 51 provided is two, one of the two slide rails 51 is inserted through the two right engaging portions 40b arranged in the sub-scanning direction X, and the other one of the two slide rails 51 is inserted through the two left engaging portions 40b arranged in the sub-scanning direction X. The number of slide rails 51, however, is not limited to two.

The first base 52 supports the table 40 such that the table 40 is movable in the sub-scanning direction X. The first base 52 is disposed over the lift 60 (see FIG. 2). As illustrated in FIG. 5, the upper surface 52a of the first base 52 has a rectangular or substantially rectangular shape whose length is shorter in the main scanning direction Y than in the sub-scanning direction X in a plan view. Alternatively, the upper surface 52a of the first base 52 may have a rectangular or substantially rectangular shape whose length is shorter in the sub-scanning direction X than in the main scanning direction Y. Optionally, the upper surface 52a of the first base 52 may have a rectangular shape whose lengths in the sub-scanning direction X and the main scanning direction Y are equal or substantially equal to each other. The first base 52 includes side walls 52b extending substantially vertically from the upper surface 52a. The side walls 52b are provided with holes 52ba. The holes 52ba are defined through the side walls 52b in the main scanning direction Y. The upper surface 52a of the first base 52 is provided with the through holes 52aa defined therethrough in the up-down direction Z. The through holes 52aa are equal in number to the slide rails 51. In the present example embodiment, the number of through holes 52aa is two, and the two through holes 52aa are arranged in the main scanning direction Y. The engaging portions 40b (see FIG. 4) and the connectors 40c (see FIG. 4), which are included in the table 40, are inserted through the through holes 52aa in the up-down direction Z. Specifically, the table body 40a of the table 40 is disposed above the through holes 52aa, and the engaging portions 40b are disposed below the through holes 52aa. As illustrated in FIG. 6, the fixtures 52c are disposed under the upper surface 52a of the first base 52. The fixtures 52c include plates to fix the slide rails 51. The number of fixtures 52c is four in total, and the four fixtures 52c are divided into two front fixtures 52c arranged in the main scanning direction Y, and two rear fixtures 52c arranged in the main scanning direction Y. The four fixtures 52c are also divided into two right fixtures 52c arranged in the sub-scanning direction X, and two left fixtures 52c arranged in the sub-scanning direction X. The ends of each slide rail 51 are fixed to an associated pair of the fixtures 52c arranged in the sub-scanning direction X. The upper surface 52a of the first base 52 is provided with holes (not illustrated) through which the raising and lowering shafts 72 are to be inserted. The raising and lowering shafts 72 are inserted through these through holes in the up-down direction Z.

The slide apparatus 50 includes the conveyor 53. The conveyor 53 includes a front pulley 53a, a rear pulley 53b, and a belt 53c. The front pulley 53a is provided on a front portion of the first base 52. The rear pulley 53b is provided on a rear portion of the first base 52. The belt 53c is wound around the pulleys 53a and 53b.

As illustrated in FIG. 5, the conveying motor 54 is disposed on the upper surface 52a of the first base 52. The conveying motor 54 is electrically connected to, for example, a controller (not illustrated) of the printer 10 and is thus controlled by the controller. The conveying motor 54 includes a rotary shaft 54a. As illustrated in FIG. 6, the rotary shaft 54a is inserted through the first base 52 such that the rotary shaft 54a extends downward from the first base 52. A gear (not illustrated) is attached to a portion of the rotary shaft 54a adjacent to its lower end. Through the gear, the rotary shaft 54a and the pulley 53b are rotatably connected to each other under the first base 52. The pulley 53b rotates upon rotation of the rotary shaft 54a of the conveying motor 54. The rotation of the pulley 53b causes the belt 53c to run. The running of the belt 53c rotates the pulley 53a around which the belt 53c is wound. The table 40 is connected to the belt 53c. Accordingly, the rotation of the rotary shaft 54a of the conveying motor 54 moves the table 40 in the sub-scanning direction X.

As illustrated in FIG. 10, the lift 60 moves the first base 52 in the up-down direction Z relative to the second base 63. The height of the table 40 in the up-down direction Z is adjusted by moving the first base 52 in the up-down direction Z.

As illustrated in FIG. 2, the raising and lowering shafts 72 include screw shafts 72a and slide shafts 72b. The screw shafts 72a and the slide shafts 72b stand on the second base 63. The screw shafts 72a include right screw shafts 72a and left screw shafts 72a. The right screw shafts 72a are provided in a pair in the sub-scanning direction X, and the left screw shafts 72a are provided in a pair in the sub-scanning direction X. In the present example embodiment, the slide shafts 72b are provided in a pair in the main scanning direction Y. The right screw shafts 72a are provided in a pair in the sub-scanning direction X for the right slide shaft 72b, and the left screw shafts 72a are provided in a pair in the sub-scanning direction X for the left slide shaft 72b.

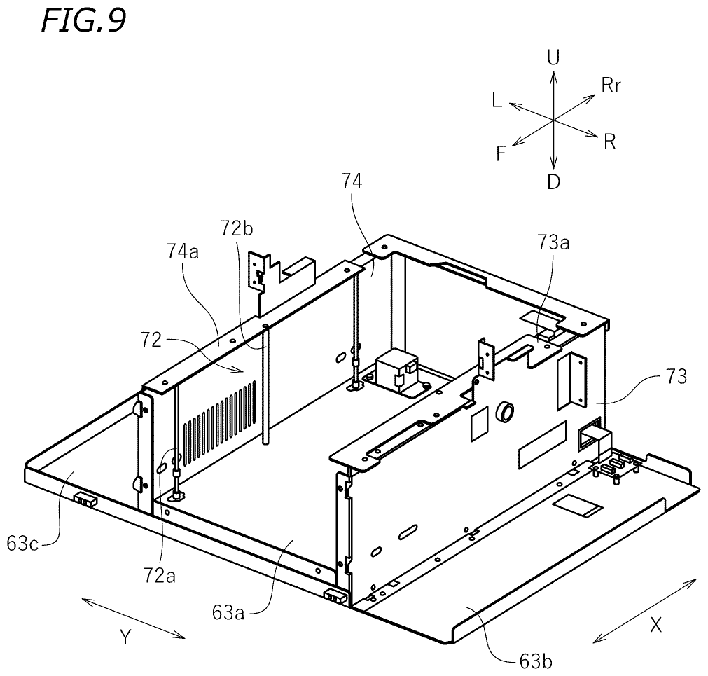

The slide shafts 72b provide a reference position for movement of the first base 52 in the up-down direction Z relative to the second base 63. The slide shafts 72b stand on the second base 63 and extend in a direction substantially perpendicular to the second base 63. Each slide shaft 72b is disposed at an intermediate position between the associated screw shafts 72a provided in a pair in the sub-scanning direction X. Adjustments are made to the slide shafts 72b such that the slide shafts 72b are perpendicular or substantially perpendicular to the second base 63. Specifically, the slide shafts 72b are fixed to the second base 63 through an assembly jig (not illustrated). After adjustments have been made to the slide shafts 72b such that the slide shafts 72b are perpendicular or substantially perpendicular to the second base 63, the assembly jig is removed. As illustrated in FIG. 6, the slide shafts 72b are provided with the bushings 55 for slidable connection with the first base 52. The slide shafts 72b are inserted through the bushings 55. A lower end of each slide shaft 72b is fixed to the second base 63 (see FIG. 10). An upper end of each slide shaft 72b is fixed to a first horizontal portion 73a (see FIG. 9) of the first side wall 73 or a second horizontal portion 74a (see FIG. 9) of the second side wall 74, which will be described below.

As illustrated in FIG. 6, the bushings 55 are cylindrical members which are fixed to the first base 52 and through which the slide shafts 72b (see FIG. 9) are inserted. The bushings 55 are fixed to the first base 52 through, for example, screws. Upon movement of the first base 52 in the up-down direction Z, which is caused by rotation of the screw shafts 72a (which will be described below), the bushings 55 also move in the up-down direction Z along the slide shafts 72b (see FIG. 9).

As illustrated in FIG. 9, the screw shafts 72a stand on the second base 63 and extend in a direction substantially perpendicular to the second base 63. In the present example embodiment, the screw shafts 72a are smaller in outer diameter than the slide shafts 72b. As illustrated in FIG. 8, the nuts 56 are screwed to the screw shafts 72a. In the present example embodiment, the nuts 56 are hexagonal nuts and are in abutment with the holders 57 fixed to the first base 52. Accordingly, the screw shafts 72a are connected to the first base 52 through the holders 57. Rotation of the screw shafts 72a moves the nuts 56 in the up-down direction Z. This causes the first base 52, which is fixed to the holders 57, to move in the up-down direction Z. As illustrated in FIG. 10, lower ends of the screw shafts 72a are connected to pulley shafts 61f of the vertical mover 61 (which will be described below). The screw shafts 72a are thus connected to pulleys 61d through the pulley shafts 61f. As illustrated in FIG. 9, an upper end of each screw shaft 72a is fixed to the first horizontal portion 73a of the first side wall 73 or the second horizontal portion 74a of the second side wall 74, which will be described below.

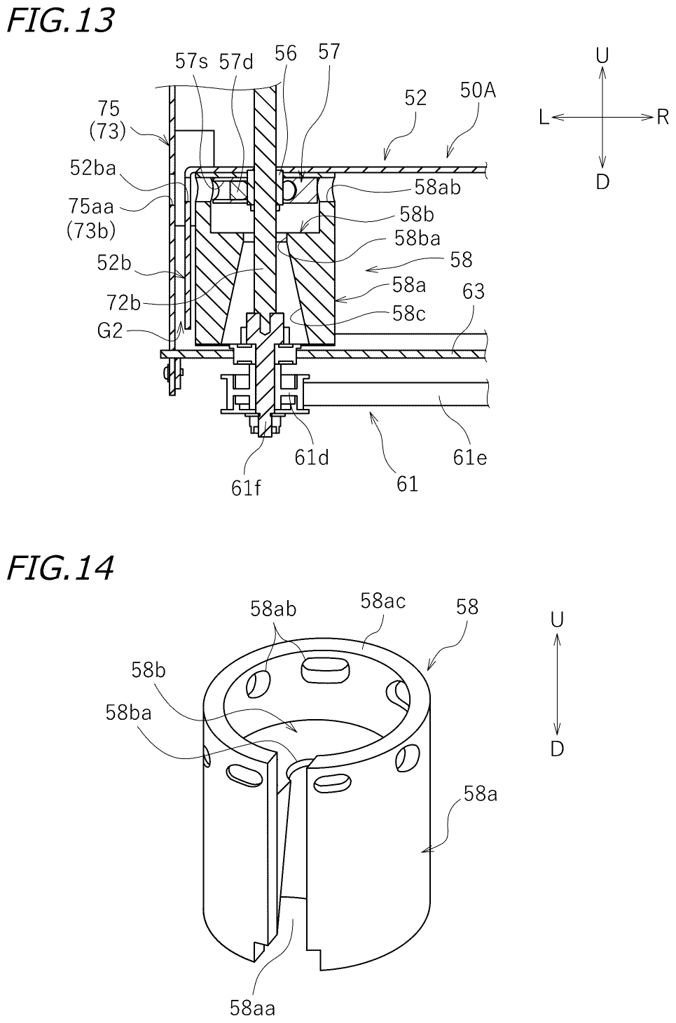

As illustrated in FIG. 8, each holder 57 is provided with screws 57a and spacers 57b, each of which is located radially outward of the associated nut 56. The screws 57a are provided in a pair for each screw shaft 72a. The spacers 57b each have a cylindrical shape and are each disposed around the associated screw 57a. The screws 57a and the spacers 57b are inserted in the through holes 57p defined through the holders 57 in the up-down direction Z. A gap G1 is created between a wall surface of each through hole 57p and the associated spacer 57b. The spacers 57b are slightly longer in length in the up-down direction Z than the holders 57. Upper ends of the spacers 57b are in contact with the first base 52. Grease (not illustrated) is applied between the first base 52 and the upper end of each spacer 57b. Washers 57c are disposed under the spacers 57b. The screws 57a are attached to the first base 52 while being brought into abutment with lower surfaces of the washers 57c, with the result that the spacers 57b are fixed through the washers 57c. Because the spacers 57b are slightly longer in length in the up-down direction Z than the holders 57 as previously mentioned, the holders 57 are not fixed. Accordingly, each holder 57 is configured to be movable in a horizontal direction by a distance corresponding to the gap G1. During horizontal movement of each holder 57, the grease applied between the first base 52 and the upper end of each spacer 57b would allow each holder 57 to move relatively smoothly if the first base 52 and the upper end of each spacer 57b are in contact with each other. The holders 57 are each provided with adjustment screw holes 57s (see FIG. 13) extending in a radial direction of each holder 57. Set screws 57d (see FIG. 13) are each disposed in an associated one of the adjustment screw holes 57s. Tightening of each set screw 57d causes each set screw 57d to abut against the associated nut 56 so as to enable the associated holder 57 to move in a perpendicular direction. In the present example embodiment, the number of adjustment screw holes 57s and the number of set screws 57d provided for each holder 57 are both two. In this example embodiment, the first base 52 is attached to each holder 57 through a predetermined jig 58 using the associated slide shaft 72b as a reference, such that the first base 52 moves in the up-down direction Z while being in parallel or substantially in parallel with the second base 63 (or the ink heads 34). This process involves adjusting the parallelism of the first base 52 with respect to the second base 63. When the nuts 56 screwed to the screw shafts 72a move in the up-down direction Z, the screw shafts 72a may unfortunately deflect due to dimensional tolerances of the screw shafts 72a. Deflection of the screw shafts 72a increases loads applied to the screw shafts 72a during movement of the first base 52 in the up-down direction Z relative to the second base 63. The gaps G1, however, allow the holders 57 to move in the horizontal direction, and the holders 57 are thus configured to be able to accommodate deflection of the screw shafts 72a. Adjusting the degree of screwing of the set screws 57d changes the positions of the holders 57 relative to the gaps G1. This makes it possible to adjust the direction and degree of deflection of the screw shafts 72a. Consequently, the present example embodiment is able to maintain the parallelism of the first base 52 with respect to the second base 63 during movement of the nuts 56 in the up-down direction Z.

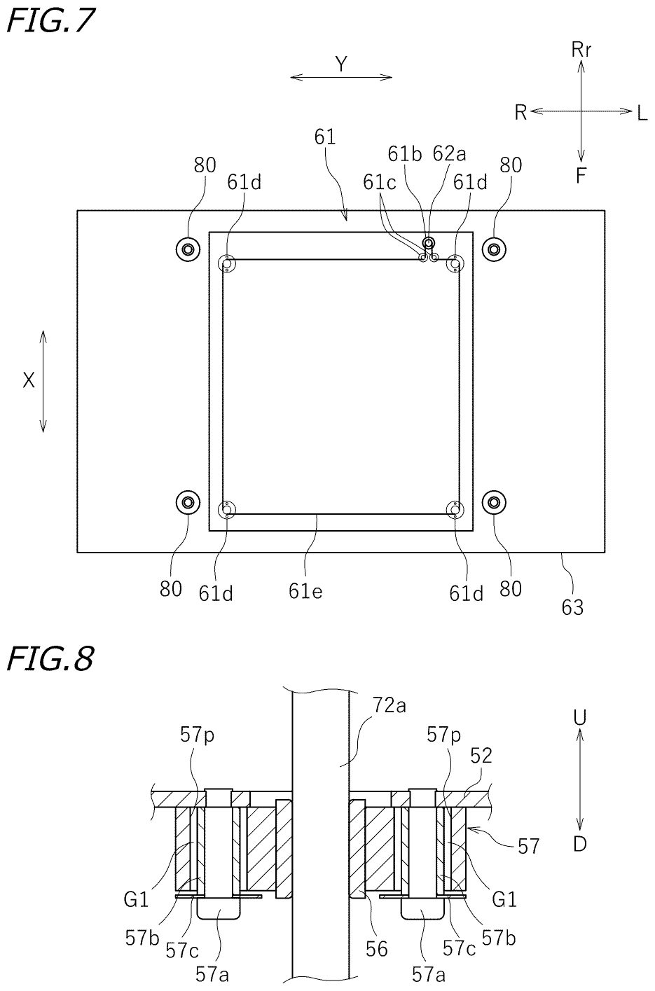

As illustrated in FIG. 7, the vertical mover 61 is a driver to move the first base 52 in the up-down direction Z relative to the second base 63. The vertical mover 61 is provided on a lower surface of the second base 63. FIG. 7 is a diagram of the second base 63 as viewed from below. The vertical mover 61 includes a motor pulley 61b, two tension pulleys 61c, the pulleys 61d, a belt 61e, and the pulley shafts 61f (see FIG. 10). The two tension pulleys 61c are disposed in front of the motor pulley 61b. The pulleys 61d are disposed at four locations such that the pulleys 61d are located at the vertices of a rectangle. Alternatively, the vertical mover 61 may include any other suitable number of tension pulleys 61c and any other suitable number of pulleys 61d. The tension pulleys 61c and the pulleys 61d may be disposed at any other suitable locations. The belt 61e is wound around the motor pulley 61b, the tension pulleys 61c, and the pulleys 61d. The tension pulleys 61c apply a predetermined tension to the belt 61e. As illustrated in FIG. 10, each pulley shaft 61f is inserted through an associated one of the pulleys 61d. The screw shafts 72a are connected to the pulley shafts 61f. Accordingly, rotation of the pulleys 61d results in rotation of the screw shafts 72a through the pulley shafts 61f.

The raising and lowering motor 62 is provided on the second base 63. The raising and lowering motor 62 is electrically connected to, for example, the controller (not illustrated) of the printer 10 and is thus controlled by the controller. The raising and lowering motor 62 includes a rotary shaft (not illustrated). An extremity of the rotary shaft is connected with the motor pulley 61b illustrated in FIG. 7. The second base 63 is provided with a hole (not illustrated) which is defined therethrough in the up-down direction Z and through which the rotary shaft of the raising and lowering motor 62 is inserted. Rotation of the rotary shaft of the raising and lowering motor 62 causes the motor pulley 61b to rotate. The rotation of the motor pulley 61b causes the belt 61e to run. The running of the belt 61e rotates the tension pulleys 61c and the pulleys 61d around which the belt 61e is wound. The rotation of the pulleys 61d causes the screw shafts 72a to rotate, resulting in movement of the slide apparatus 50 in the up-down direction Z along the slide shafts 72b.

As illustrated in FIG. 10, the second base 63 is a structure supporting the table moving mechanism 90. The second base 63 is disposed under the slide apparatus 50. As illustrated in FIG. 9, the second base 63 includes a first bottom 63a, a second bottom 63b, and a third bottom 63c. The first bottom 63a is a region of the second base 63 located between the first side wall 73 and the second side wall 74 in the main scanning direction Y. The slide apparatus 50 (see FIG. 2) is disposed over the first bottom 63a. The second bottom 63b is a region of the second base 63 located rightward relative to the first side wall 73. The third bottom 63c is a region of the second base 63 located leftward relative to the second side wall 74. The body frame 14 (see FIG. 2) is placed on the second bottom 63b and the third bottom 63c. Although not illustrated, ink tank(s) storing ink, for example, may be disposed on the second bottom 63b and/or the third bottom 63c.

The first side wall 73 and the second side wall 74 are upwardly extending plates provided on the second base 63. The first side wall 73 is disposed rightward relative to the second side wall 74. The first side wall 73 and the second side wall 74 support the slide shafts 72b and the screw shafts 72a. The first side wall 73 includes the first horizontal portion 73a extending leftward from an upper end of the first side wall 73. The second side wall 74 includes the second horizontal portion 74a extending rightward from an upper end of the second side wall 74. Upper ends of the raising and lowering shafts 72 are fixed to the first horizontal portion 73a and the second horizontal portion 74a.

As illustrated in FIG. 10, legs 80 are disposed under the second base 63. In the present example embodiment, the number of legs 80 is four, and the four legs 80 are provided on a lower surface of the first bottom 63a of the second base 63 so as to support the slide apparatus 50. Any suitable material may be used for the legs 80. A material that is able to prevent or reduce vibrations of the printer 10 is preferably used for the legs 80. In one example, the legs 80 are made of rubber. Because the legs 80 extend downward from the first bottom 63a, a gap equal or substantially equal in length in the up-down direction Z to each leg 80 is created between the lower surface of the first bottom 63a and a placement surface for the printer 10. In the present example embodiment, a length H1 of the vertical mover 61 in the up-down direction Z is shorter than a length H2 of each leg 80 in the up-down direction Z. The number of legs 80 is not limited to four.

In the table moving mechanism 90 according to the present example embodiment, the table 40 having the recording medium 5 placed thereon is moved by the slide apparatus 50 and the lift 60 as described above. The conveyor 53 of the slide apparatus 50 moves the table 40 in the sub-scanning direction X relative to the first base 52 along the slide rails 51. The vertical mover 61 of the lift 60 moves the first base 52 in the up-down direction Z relative to the second base 63 along the raising and lowering shafts 72. The movement of the first base 52 in the up-down direction Z results in movement of the table 40 in the up-down direction Z. In the table moving mechanism 90, the first base 52 supporting the table 40 is moved in the up-down direction Z relative to the second base 63 by the lift 60. Accordingly, the present example embodiment makes it unnecessary for the table moving mechanism 90 to have a dual-box shape required for table moving mechanisms known in the related art. Consequently, the table moving mechanism 90 is small in size.

In the table moving mechanism 90 according to the present example embodiment, the slide rails 51 support the table 40, and the table 40 is moved in the sub-scanning direction X along the slide rails 51 by the conveyor 53. During this movement, the slide rails 51 receive a load from the table 40. The slide rails 51 are provided on the first base 52. The first base 52 is moved in the up-down direction Z by the vertical mover 61. The first base 52 moves in the up-down direction Z along the raising and lowering shafts 72 standing on the second base 63 and in engagement with the first base 52. Thus, a downward load applied to the slide rails 51 is constituted by the load applied thereto from the table 40, with the result that the slide rails 51 receive no load from the lift 60 that moves the table 40 in the up-down direction Z. In the table moving mechanism 90, the number of components that apply a downward load to the slide rails 51 and the load applied to the slide rails 51 are smaller than in table moving mechanisms known in the related art. This would make it unlikely for the slide rails 51 to deflect downward if the table 40 is relatively large in size and weight. Because the table 40 is in engagement with the slide rails 51, downward deflection of the slide rails 51 moves the table 40 downward, or in other words, changes the height of the table 40. A change in the height of the table 40 results in a change in the height of the recording medium 5 placed on the table 40. An interval between the recording medium 5 and the ink head unit 30 disposed above the table 40 is desirably kept constant. This is because the constant interval between the recording medium 5 and the ink head unit 30 makes it unlikely for ink landing positions to deviate from desired positions and thus makes it possible to maintain the quality of a resulting printed matter. A change in the height of the recording medium 5 caused by a change in the height of the table 40 may unfortunately raise the possibility of being unable to keep the interval between the recording medium 5 and the ink head unit 30 constant if the height of the table 40 is adjusted by the vertical mover 61. Preventing deflection of the slide rails 51 as in the present example embodiment, however, will prevent this possibility. Accordingly, the present example embodiment makes it unlikely for the slide rails 51 to distort and thus makes it possible to maintain the quality of a resulting printed matter. A table moving mechanism having a dual-box shape, which is known in the related art, is relatively large in size and requires a relatively large force to actuate its conveyor and its vertical mover. The table moving mechanism 90 according to the present example embodiment, however, is small in size and thus relatively light in weight. Consequently, the table moving mechanism 90 according to the present example embodiment is able to move the table 40 without the need for a relatively large force to actuate the conveyor 53 and the vertical mover 61.

In the table moving mechanism 90 according to the present example embodiment, the slide rails 51 are disposed under the first base 52. The connectors 40c of the table 40 are inserted through the through holes 52aa of the first base 52. The slide rails 51 are inserted through the engaging portions 40b under the first base 52. Inserting the slide rails 51 through the engaging portions 40b enables the table 40 to move in the sub-scanning direction X relative to the first base 52. The table body 40a of the table 40 is disposed above the through holes 52aa. Thus, the length of the slide apparatus 50 in the up-down direction Z is shorter than when the slide rails 51 are disposed over the first base 52. Consequently, the present example embodiment is able to prevent an increase in the length of the table moving mechanism 90 in the up-down direction Z.

In the table moving mechanism 90 according to the present example embodiment, the vertical mover 61 is provided on the lower surface of the second base 63. Suppose that the vertical mover 61 is provided on an upper surface of the first bottom 63a of the second base 63. In this case, in order to prevent contact between the first base 52 and the vertical mover 61, the distance covered by the slide apparatus 50 in the up-down direction z is limited in accordance with the height of the vertical mover 61 in the up-down direction Z. This case also requires increasing the lengths of the raising and lowering shafts 72, the first side wall 73, and the second side wall 74 in the up-down direction Z in accordance with the height of the vertical mover 61 in the up-down direction Z. In the present example embodiment, however, the vertical mover 61 is disposed under the second base 63. Consequently, the present example embodiment does not require a change in the distance covered by the slide apparatus 50 in the up-down direction Z and is able to prevent an increase in the height of the table moving mechanism 90 in the up-down direction Z.

In the table moving mechanism 90 according to the present example embodiment, the legs 80 and the vertical mover 61 are provided on the lower surface of the first bottom 63a. The length H1 of the vertical mover 61 in the up-down direction Z is shorter than the length H2 of each leg 80 in the up-down direction Z. Consequently, if the table moving mechanism 90 is placed by bringing the legs 80 into contact with the placement surface for the printer 10, the present example embodiment would prevent the vertical mover 61 from coming into contact with the placement surface.

In the table moving mechanism 90 according to the present example embodiment, the raising and lowering shafts 72 include the screw shafts 72a and the slide shafts 72b. The nuts 56 are screwed to the screw shafts 72a. The holders 57 fixed to the first base 52 are screwed to the nuts 56. Tightening of set screws (not illustrated) screwed to the holders 57 in the radial direction enables movement of the nuts 56 in the right-left direction and the front-rear direction. The movement of the nuts 56 enables adjustments to the verticality of longitudinal axes of the screw shafts 72a relative to the second base 63. Accordingly, the screw shafts 72a are configured to be adjustable such that the longitudinal axes of the screw shafts 72a are parallel or substantially parallel to the slide shafts 72b. Because the present example embodiment enables the longitudinal axes of the screw shafts 72a to be parallel or substantially parallel to the slide shafts 72b, the first base 52 is raisable and lowerable while being kept parallel or substantially parallel to the second base 63. Consequently, the table 40 and the recording medium 5 are raised and lowered while being kept parallel or substantially parallel to the placement surface for the printer 10.

In the table moving mechanism 90 according to the present example embodiment, the bushings 55 including the slide shafts 72b inserted therethrough are fixed to the first base 52 such that the bushings 55 are immovable relative to the first base 52. Because the nuts 56 are movable in the main scanning direction Y and the sub-scanning direction X relative to the first base 52, the present example embodiment is able to accommodate component tolerances and slight movements of the screw shafts 72a to which the nuts 56 are screwed.

In the table moving mechanism 90 according to the present example embodiment, the screw shafts 72a are provided in a pair in the sub-scanning direction X for each slide shaft 72b. Each slide shaft 72b is disposed at the intermediate position between the associated screw shafts 72a provided in a pair in the sub-scanning direction X. This enables stable raising and lowering of the table 40. Making the slide shafts 72b perpendicular or substantially perpendicular to the second base 63 with the use of the assembly jig, for example, makes the first base 52 and the table 40 parallel or substantially parallel to the placement surface. In this state, the nuts 56 and the holders 57 are fixed to each other through the screws 57a so as to maintain the horizontality of the table 40. The raising and lowering of the first base 52, however, may involve slight movements of the screw shafts 72a. In the present example embodiment, the bushings 55 having the slide shafts 72b inserted therethrough are fixed to the first base 52. The present example embodiment thus prevents slight movements of the slide shafts 72b caused by the raising and lowering of the first base 52. Consequently, the present example embodiment enables stable raising and lowering of the table 40 because each slide shaft 72b is disposed at the intermediate position between the associated screw shafts 72a provided in a pair.

The example embodiments of the present invention have been described thus far. The foregoing example embodiments, however, are only illustrative. The present invention may be embodied in various other forms and example embodiments.

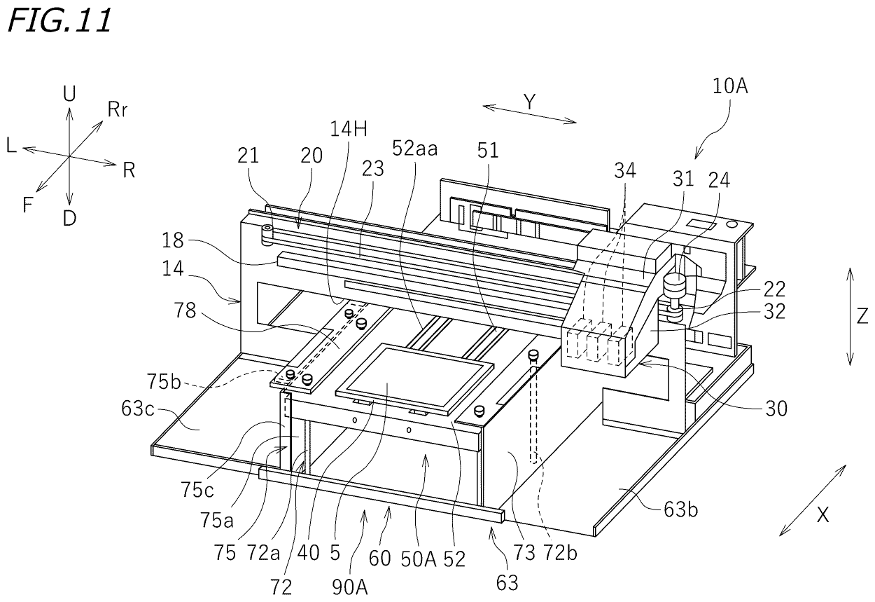

The following description discusses a table moving mechanism 90A according to a second example embodiment of the present invention. In the following description on the second example embodiment, components similar in function to those described in the first example embodiment will be identified by the same reference signs as those used in the first example embodiment and will be described briefly or will not be described when deemed redundant. FIG. 11 is a perspective view of the inside of a printer 10A according to the second example embodiment. The table moving mechanism 90A includes a second side wall 75, a fixture 78, and a slide apparatus 50A.

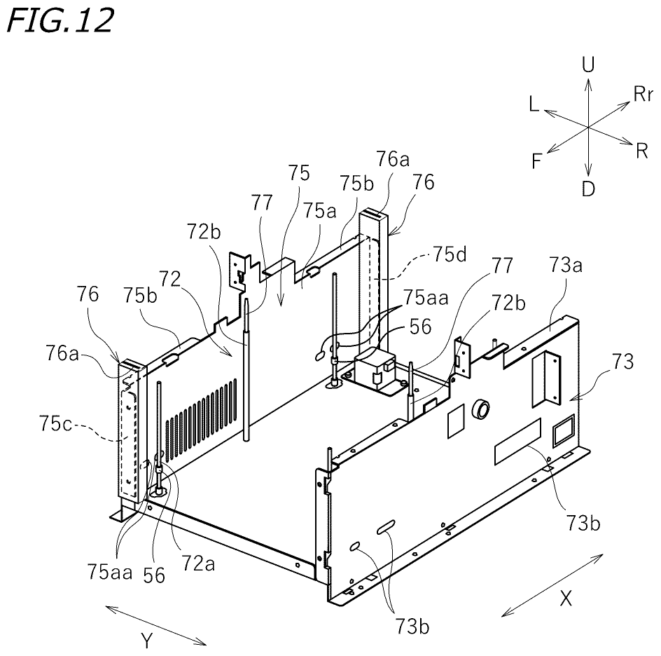

FIG. 12 is a perspective view of a portion of a lift 60 according to the second example embodiment and its vicinity. As illustrated in FIG. 12, the second side wall 75 extends in a longitudinal direction of raising and lowering shafts 72. The raising and lowering shafts 72 include left raising and lowering shafts 72 (i.e., left screw shafts 72a and a left slide shaft 72b) and right raising and lowering shafts 72 (i.e., right screw shafts 72a and a right slide shaft 72b). The left raising and lowering shafts 72 are each provided in a pair with an associated one of the right raising and lowering shafts 72 in a main scanning direction Y. In the present example embodiment, the second side wall 75 extends in the longitudinal direction of the left raising and lowering shafts 72. The second side wall 75 stands at substantially right angles to a second base 63. As illustrated in FIG. 11, the second side wall 75 is disposed outward of a first base 52 in the main scanning direction Y. In the present example embodiment, the second side wall 75 is disposed leftward of the first base 52. Within a raising and lowering range of the first base 52, a predetermined gap G2 (see FIG. 13) is created between the second side wall 75 and the first base 52. In the present example embodiment, the gap G2 is created between a side wall 52b (see FIG. 13) of the first base 52 and the second side wall 75 in the main scanning direction Y. The gap G2 preferably has a size in the range of about 2 mm to about 4 mm, for example. The second side wall 75 is an example of a side wall according to an example embodiment of the present invention. The second side wall 75 serves as an attaching guide for the first base 52 during assembly of the printer 10A. How the first base 52 is to be attached to the raising and lowering shafts 72 will be described below. As illustrated in FIG. 12, a first side wall 73 is provided with holes 73b defined therethrough in the main scanning direction Y. The holes 73b may each have any suitable size and shape.

In the present example embodiment, the second side wall 75 includes a side portion 75a extending in an up-down direction Z, horizontal portions 75b each extending leftward from an upper end of the side portion 75a, a front end portion 75c extending rightward from a front end of the side portion 75a, and a rear end portion 75d extending rightward from a rear end of the side portion 75a. The horizontal portions 75b, the front end portion 75c, and the rear end portion 75d are each connected at substantially right angles to the side portion 75a. In the present example embodiment, the number of horizontal portions 75b provided is two, and the two horizontal portions 75b are arranged in a sub-scanning direction X. Alternatively, the second side wall 75 may include any other suitable number of horizontal portions 75b. In an alternative arrangement, the second side wall 75 may be disposed rightward of the first base 52. In the alternative arrangement, the second side wall 75 extends in the longitudinal direction of the right raising and lowering shafts 72, each of which is provided in a pair with an associated one of the left raising and lowering shafts 72 in the main scanning direction Y. In the alternative arrangement, the horizontal portions 75b extend rightward from the upper end of the side portion 75a. The side portion 75a is provided with holes 75aa defined therethrough in the main scanning direction Y, and the holes 75aa are disposed leftward of nuts 56.

Jigs 76 are attached to the second side wall 75. The jigs 76 serve to determine positioning of the first base 52 (see FIG. 11) in the sub-scanning direction X. The jigs 76 are each attached to an associated one of the front end portion 75c and the rear end portion 75d. The jigs 76 extend in the up-down direction Z. The jigs 76 extend upward relative to the second side wall 75. The jigs 76 are provided with slits 76a extending rightward from left end surfaces of the jigs 76. The front end portion 75c and the rear end portion 75d are each fitted into an associated one of the slits 76a, with the result that the jigs 76 are attached to the second side wall 75.

Jigs 77 are attached to the slide shafts 72b. The jigs 77 are each attached to an associated one of the slide shafts 72b provided in a pair. The jigs 77 extend in the up-down direction Z. The jigs 77 are attached to upper ends of the slide shafts 72b. Bottom surfaces of the jigs 77, for example, are provided with screws (not illustrated). With these screws, the jigs 77 are attached to the upper ends of the slide shafts 72b. Upper ends of the jigs 77 are located above upper ends of the screw shafts 72a. Because the jigs 76 and 77 are respectively attached to the second side wall 75 and the slide shafts 72b during assembly of the printer 10A, the jigs 76 and 77 are not illustrated in the drawings other than FIG. 12.

As illustrated in FIG. 11, the fixture 78 is attached to the horizontal portions 75b of the second side wall 75. The fixture 78 is disposed above the first base 52. The fixture 78 is a plate extending in the sub-scanning direction X. A left end of the fixture 78 substantially corresponds in position to left ends of the horizontal portions 75b of the second side wall 75. A right end of the fixture 78 is disposed rightward relative to the left screw shafts 72a and the left slide shaft 72b, each of which is provided in a pair with an associated one of the right screw shafts 72a and the right slide shaft 72b in the main scanning direction Y. The upper ends of the left screw shafts 72a and the left slide shaft 72b, which are included in the raising and lowering shafts 72, are attached and fixed to the fixture 78. The screw shafts 72a and the slide shafts 72b may be fixed by any other suitable method. The screw shafts 72a and the slide shafts 72b may be fixed, for example, with screws and/or nuts.

FIG. 13 is a cross-sectional view of the slide apparatus 50A. As illustrated in FIG. 13, the slide apparatus 50A includes guiding jigs 58. The guiding jigs 58 serve as attaching guides for the first base 52 during assembly of the printer 10A. The guiding jigs 58 are attached to a bottom surface of the first base 52. The guiding jigs 58 are attached to the first base 52 such that each guiding jig 58 covers an associated holder 57. FIG. 14 is a perspective view of the guiding jig 58. As illustrated in FIG. 14, each guiding jig 58 includes an outer diameter portion 58a, a partition wall 58b, and an inclined wall 58c (see FIG. 13).

The following description focuses on one of the guiding jigs 58 with reference to FIGS. 13 and 14. The outer diameter portion 58a has a partially cut-out cylindrical shape and is thus C-shaped in a plan view. The cut-out portion of the outer diameter portion 58a will be referred to as a “cut-out 58aa”. A width of the cut-out 58aa in a front view is larger than a width of each screw shaft 72a (see FIG. 13) in the front view. A lateral surface of the outer diameter portion 58a is provided with holes 58ab. Each hole 58ab is defined through the guiding jig 58 in a radial direction thereof. The outer diameter portion 58a may be provided with any suitable number of holes 58ab. The holes 58ab may each have any suitable shape. As illustrated in FIG. 14, an upper end of the outer diameter portion 58a is provided with a magnetic surface 58ac. The magnetic surface 58ac is configured to be able to attract a magnetic material. The magnetic surface 58ac is suctioned onto the first base 52. In one example, the magnetic surface 58ac may be provided by affixing a magnet to the upper end of the outer diameter portion 58a.

The partition wall 58b is a partition extending in the radial direction of the guiding jig 58 inside the outer diameter portion 58a. As illustrated in FIG. 13, the associated holder 57 is housed in a portion of an internal space of the outer diameter portion 58a, which is located above the partition wall 58b. The partition wall 58b is substantially C-shaped in the plan view. The partition wall 58b is provided with an insertion hole 58ba defined therethrough in the up-down direction Z. In the plan view, the insertion hole 58ba includes an arc-shaped portion located in the radial center of the guiding jig 58, and an extension continuous with the arc-shaped portion and extending outward from the radial center. The insertion hole 58ba has the associated screw shaft 72a inserted therethrough. The insertion hole 58ba is in communication with the cut-out 58aa in the radial direction of the guiding jig 58.

The inclined wall 58c is disposed below the partition wall 58b inside the outer diameter portion 58a. The inclined wall 58c is connected to the insertion hole 58ba and a lower end of the outer diameter portion 58a. The inclined wall 58c spreads outward in the radial direction of the guiding jig 58 as the inclined wall 58c extends downward. In other words, the inclined wall 58c has a tapered shape.

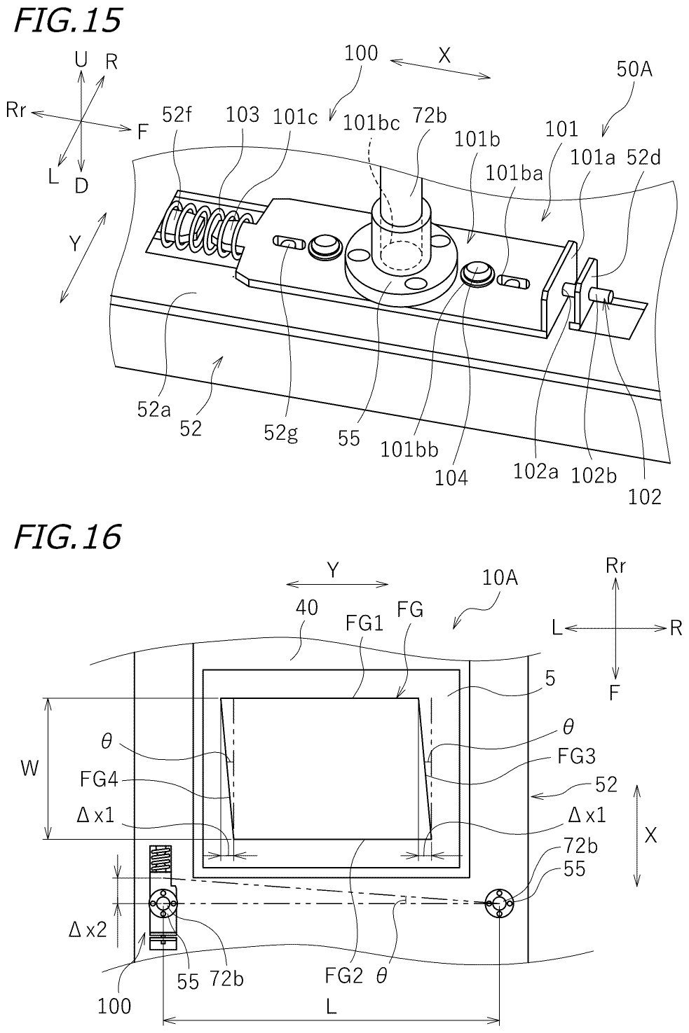

FIG. 15 is a perspective view of the first base 52. As illustrated in FIG. 15, the slide apparatus 50A includes an adjuster 100. The adjuster 100 is attached to the leftwardly disposed slide shaft 72b, which is one of the pair of slide shafts 72b. In the following description, the leftwardly disposed slide shaft 72b, which is one of the pair of slide shafts 72b, will be referred to as the “left slide shaft 72b”, and the rightwardly disposed slide shaft 72b, which is the other one of the pair of slide shafts 72b, will be referred to as the “right slide shaft 72b”. The adjuster 100 adjusts the position of the first base 52 relative to the second base 63 (see FIG. 11). As illustrated in FIG. 11, the direction of scanning by ink heads 34 and the direction of conveyance of a table 40 are desirably perpendicular to each other. In this case, the printer 10A is able to effect printing on a recording medium 5 placed on the table 40 without any print misalignment. The adjuster 100 illustrated in FIG. 15 makes an adjustment such that the direction of scanning by the ink heads 34 and the direction of conveyance of the table 40 are perpendicular to each other. The adjuster 100 includes a bracket 101, an adjusting screw 102, an adjusting piece 52d, and a compression spring 103. In the present example embodiment, a bushing 55 is attached to an upper surface of the bracket 101.

The first base 52 according to the present example embodiment is provided with the adjusting piece 52d for attachment of the adjusting screw 102, a supporter 52f, and projections 52g. The adjusting piece 52d has a plate shape extending upward from an upper surface 52a of the first base 52. The adjusting piece 52d is provided by, for example, bending a portion of the upper surface 52a upward. In this case, the adjusting piece 52d is integral with the first base 52. The adjusting piece 52d is disposed in front of the bracket 101 such that the adjusting piece 52d faces the bracket 101 in the sub-scanning direction X. The supporter 52f is a protrusion provided in the upper surface 52a and extending in the sub-scanning direction X. The supporter 52f is provided by hollowing out the upper surface 52a in the up-down direction Z. The supporter 52f is disposed in contact with the inside of the compression spring 103. The supporter 52f supports the compression spring 103 together with a third portion 101c of the bracket 101 (which will be described below). The projections 52g project upward from the upper surface 52a. The projections 52g are provided by, for example, a half-punching process. The projections 52g are each disposed inside an associated one of elongated holes 101ba (which will be described below).

The bracket 101 is movable in the sub-scanning direction X relative to the first base 52. The bracket 101 is an example of an adjuster according to an example embodiment of the present invention. The bracket 101 according to the present example embodiment includes a first portion 101a, a second portion 101b, and the third portion 101c. The first portion 101a extends in a direction perpendicular or substantially perpendicular to the upper surface 52a. The second portion 101b is connected to a lower end of the first portion 101a and extends rearward from the lower end of the first portion 101a. The third portion 101c is connected to a rear end of the second portion 101b. The third portion 101c is shorter in length in the main scanning direction Y than the second portion 101b. The third portion 101c extends rearward from the rear end of the second portion 101b. The third portion 101c is thus provided on the rear side of the bracket 101. The third portion 101c is disposed in contact with the inside of the compression spring 103. The bracket 101 is substantially L-shaped in a side view. The second portion 101b is provided with the elongated holes 101ba defined through the second portion 101b in the up-down direction Z, fixed portions 101bb temporarily fastenable to the first base 52, and an insertion hole 101bc through which the left slide shaft 72b is slidably inserted. The elongated holes 101ba are longer in the sub-scanning direction X than in the main scanning direction Y. The elongated holes 101ba are provided in a pair in the sub-scanning direction X for the left slide shaft 72b. With the fixed portions 101bb temporarily fastened to the first base 52 with fixing screws 104 (which will be described below), the bracket 101 moves relative to the first base 52 in the sub-scanning direction X.

The adjusting screw 102 changes a distance between the bracket 101 and the adjusting piece 52d. The adjusting screw 102 includes an extremity 102a and a screw portion 102b. In the present example embodiment, the extremity 102a is in abutment with the first portion 101a of the bracket 101. The screw portion 102b is in engagement with the adjusting piece 52d. Thus, with the fixing screws 104 (which will be described below) temporarily fastened, i.e., with the fixing screws 104 not secured, screwing of the adjusting screw 102 causes the first portion 101a to move rearward. This increases the distance between the bracket 101 and the adjusting piece 52d. Because the bracket 101 is pushed by the compression spring 103, loosening of the adjusting screw 102 causes the first portion 101a to move forward. This reduces the distance between the bracket 101 and the adjusting piece 52d. Examples of the adjusting screw 102 includes a set screw. The adjusting screw 102 may be configured such that the extremity 102a is in abutment with a rear surface of the adjusting piece 52d and the screw portion 102b is in engagement with the first portion 101a. In this case, with the extremity 102a in abutment with the adjusting piece 52d, screwing or loosening of the adjusting screw 102 causes the bracket 101 to move in the sub-scanning direction X relative to the first base 52. The pair of slide shafts 72b each have its upper end fixed to the first side wall 73 or the second side wall 75 (see FIG. 11) and each have its lower end fixed to the second base 63 (see FIG. 10), with the result that the slide shafts 72b remain unchanged in position. Accordingly, screwing or loosening of the adjusting screw 102 pushes the adjusting piece 52d toward the bracket 101 having the left slide shaft 72b fixed thereto. This rotates the first base 52 around the right slide shaft 72b (see FIG. 16), resulting in movement of the first base 52 relative to the bracket 101 (i.e., relative to the left slide shaft 72b).

The compression spring 103 urges the bracket 101 forward. The compression spring 103 is an example of a biasing structure according to an example embodiment of the present invention. The compression spring 103 is supported by the supporter 52f and the third portion 101c. The compression spring 103 is thus in engagement with the bracket 101 and the first base 52. The compression spring 103 is disposed behind the bracket 101. The compression spring 103 is attached to the supporter 52f and the third portion 101c such that a portion of the compression spring 103 is disposed above the upper surface 52a. A front end of the compression spring 103 is in contact with the rear end of the second portion 101b of the bracket 101. Accordingly, the second portion 101b is urged forward by the compression spring 103. Because the compression spring 103 urges the bracket 101 forward, the bracket 101 would abut against the adjusting screw 102 if the adjusting screw 102 is loosened and thus moved forward.

The fixing screws 104 are attached to the second portion 101b of the bracket 101. The fixing screws 104 fix the position of the bracket 101 in the sub-scanning direction X. With the fixing screws 104 attached to the second portion 101b, i.e., with the bracket 101 fixed in position, the bracket 101 is immovable in the sub-scanning direction X. One of the fixing screws 104 is disposed in front of the left slide shaft 72b, and the other one of the fixing screws 104 is disposed behind the left slide shaft 72b. Although not illustrated, the bracket 101 and the first base 52 are provided with screw holes for attachment of the fixing screws 104.

The above description has discussed the structure of the printer 10A according to the second example embodiment. The following description discusses operations for attaching the first base 52 to the raising and lowering shafts 72.

As illustrated in FIG. 12, the first side wall 73, the second side wall 75, and the raising and lowering shafts 72 are attached to the second base 63. An operator brings down the first base 52 (see FIG. 11) from above the raising and lowering shafts 72 such that the first base 52 is attached to the raising and lowering shafts 72. In this operation, the operator first determines positioning of the first base 52 in the main scanning direction Y and the sub-scanning direction X such that the jigs 77 pass through the bushings 55 (see FIG. 16). The first base 52 is disposed between the jig 76 attached to the front end portion 75c and the jig 76 attached to the rear end portion 75d, with the result that the bushings 55 and the jigs 77 substantially correspond in position in the sub-scanning direction X. After the jigs 77 have passed through the bushings 55, the first base 52 is moved downward along the side portion 75a of the second side wall 75. Specifically, the operator moves the first base 52 downward while maintaining the horizontality of the first base 52 such that the side wall 52b of the first base 52 and the side portion 75a are parallel or substantially parallel to each other. In this operation, the screw shafts 72a are passed through the guiding jigs 58 and inserted through the first base 52.

Upon insertion of the screw shafts 72a through the guiding jigs 58 (which is illustrated in FIG. 13) from their lower ends, the screw shafts 72a pass through the insertion holes 58ba. If any one of the screw shafts 72a abuts against the associated inclined wall 58c, the operator adjusts the position of first base 52 in the horizontal direction such that this screw shaft 72a does not abut against the associated inclined wall 58c. The operator inserts the screw shafts 72a through the insertion holes 58ba while adjusting the position of the first base 52 in the horizontal position such that no screw shafts 72a abut against the inclined walls 58c. When the first base 52 has been moved downward until the lower ends of the guiding jigs 58 come into contact with the second base 63, the nuts 56 are disposed inside the holders 57. In this case, the adjustment screw holes 57s of the holders 57, the holes 58ab of the guiding jigs 58, the holes 52ba of the side walls 52b, and the holes 73b of the first side wall 73 or the holes 75aa of the second side wall 75 are disposed to overlap with each other in the up-down direction Z as viewed in the right-left direction. The operator attaches the set screws 57d to the holders 57 from positions outside the first side wall 73 or the second side wall 75 in the main scanning direction Y. This allows the nuts 56 to be raised and lowered together with the first base 52.

After the set screws 57d have been attached to the holders 57, the operator raises the first base 52 by using the vertical mover 61 and then removes the guiding jigs 58. To remove the guiding jigs 58, the operator first detaches the magnetic surfaces 58ac (see FIG. 14) of the guiding jigs 58 from the first base 52. The operator then moves the guiding jigs 58 such that the screw shafts 72a are passed through the cut-outs 58aa (see FIG. 14), resulting removal of the guiding jigs 58. As a result of the operations described above, the first base 52 is attached to the raising and lowering shafts 72.

The following description discusses a method for adjusting the position of the first base 52 relative to the second base 63 (see FIG. 11) by using the adjuster 100 illustrated in FIG. 15. Specifically, this method involves adjusting the position of the first base 52 relative to the second base 63 (see FIG. 11) such that the direction of scanning by the ink heads 34 (see FIG. 11) and the direction of conveyance of the table 40 (see FIG. 11) are perpendicular to each other.

As illustrated in FIG. 16, the operator first performs adjustment printing on the recording medium 5 by using the printer 10A. The term “adjustment printing” refers to printing of an adjustment figure FG on the recording medium 5. In the present example embodiment, the adjustment figure FG is output in accordance with print data for printing of a square shape. The adjustment figure FG is defined by an upper side FG1, a lower side FG2, a right side FG3, and a left side FG4. The right side FG3 and the left side FG4, however, are inclined leftward relative to the sub-scanning direction X by an angle θ as illustrated in FIG. 16. Accordingly, the adjustment figure FG printed is not a square, which means that the direction of scanning by the ink heads 34 and the direction of conveyance of the table 40 are not exactly perpendicular to each other. A right end of the upper side FG1 is displaced leftward relative to a right end of the lower side FG2 by a displacement amount Δx1. A left end of the upper side FG1 is displaced leftward relative to a left end of the lower side FG2 by the displacement amount Δx1. The operator is able to calculate numerical values of the angle θ and the displacement amount Δx1 by measuring dimensions of the adjustment figure FG. The dimensions of the adjustment figure FG may be adjusted by any suitable method. In actuality, the angle θ and the displacement amount Δx1 are minute, but in FIG. 16, the angle θ and the displacement amount Δx1 are presented in an exaggerated manner.

When the adjustment figure FG illustrated in FIG. 16 has been printed, the position of the first base 52 is shifted rearward with reference to the position of the left slide shaft 72b by a displacement amount Δx2, with the result that the direction of scanning by the ink heads 34 and the direction of conveyance of the table 40 are exactly perpendicular to each other. In other words, the first base 52 is moved rearward relative to the second base 63 by the displacement amount Δx2. The displacement amount Δx2 is a value uniquely determined in accordance with a length W of the adjustment figure FG in the sub-scanning direction X, an interval L between the pair of slide shafts 72b, and the angle θ. The operator is able to cancel a displacement corresponding to the angle θ by moving the first base 52 rearward with reference to the position of the left slide shaft 72b by the displacement amount Δx2. Suppose that the right side FG3 and the left side FG4 are inclined rightward relative to the sub-scanning direction X by the angle θ. In such a case, the operator is required to move the first base 52 forward with reference to the position of the left slide shaft 72b by the displacement amount Δx2.

In moving the first base 52 by the displacement amount Δx2 as described above, the operator first causes the fixing screws 104 to be temporarily fastened to the fixed portions 101bb illustrated in FIG. 15, and then screws the adjusting screw 102 of the adjuster 100 so as to move the position of the adjusting screw 102 rearward by the displacement amount Δx2. The amount of rotation of the adjusting screw 102 is uniquely determined in accordance with the value of the displacement amount Δx2 and the pitch of the adjusting screw 102. The rearward movement of the adjusting screw 102 illustrated in FIG. 15 pushes the first portion 101a of the bracket 101 rearward. The bracket 101 thus moves rearward while compressing the compression spring 103. This increases the distance between the bracket 101 and the adjusting piece 52d by the displacement amount Δx2. The projections 52g guide movement of the bracket 101 in the sub-scanning direction X. When the distance between the bracket 101 and the adjusting piece 52d has increased by the displacement amount Δx2 and the first base 52 has been moved by the displacement amount Δx2, the direction of scanning by the ink heads 34 (see FIG. 11) and the direction of conveyance of the table 40 (see FIG. 11) are exactly perpendicular to each other. In this state, the fixing screws 104 are secured to the bracket 101 so as to fix the position of the bracket 101. The operator may print the adjustment figure FG again after the above-described adjustment so as to check to see that the displacement corresponding to the angle θ has been cancelled.

In the table moving mechanism 90A according to the second example embodiment, the second side wall 75 extending in the longitudinal direction of the raising and lowering shafts 72 is disposed outward of the first base 52 in the main scanning direction Y as described above. Within the raising and lowering range of the first base 52, the predetermined gap G2 is created between the second side wall 75 and the first base 52. This enables the side portion 75a of the second side wall 75 to be used as a guide during insertion of the raising and lowering shafts 72 through the first base 52. Consequently, the second example embodiment is able to prevent, for example, the first base 52 from hitting against the raising and lowering shafts 72 by mistake.

In the table moving mechanism 90A according to the second example embodiment, the slide apparatus 50A includes the adjuster 100 to adjust the position of the first base 52 relative to the second base 63. The slide shafts 72b are provided in a pair in the main scanning direction Y and fixed to the first base 52. The adjusting piece 52d is integral with the first base 52. The adjusting piece 52d is disposed in front of the bracket 101 such that the adjusting piece 52d faces the bracket 101. With the fixing screws 104 temporarily fastened to the fixed portions 101bb, screwing of the adjusting screw 102 causes the bracket 101 to move rearward while compressing the compression spring 103. This results in an increase in the distance between the bracket 101 and the adjusting piece 52d. The amount of increase in the distance is uniquely determined in accordance with the dimensions of the adjustment figure FG and the interval between the pair of slide shafts 72b in the main scanning direction Y. Upon increase in the distance between the bracket 101 and the adjusting piece 52d and rearward movement of the first base 52, the direction of scanning by the ink heads 34 and the direction of conveyance of the table 40 are exactly perpendicular to each other. In this state, an image to be printed on the recording medium 5 is prevented from being inclined. Consequently, the second example embodiment is able to improve the quality of a resulting printed matter.

The techniques and example embodiments disclosed herein are applicable to various types of printers. The techniques and example embodiments disclosed herein are applicable not only to the flatbed type printers 10 and 10A illustrated in the forgoing example embodiments, but also to, for example, a “gantry type printer” that involves placing a medium on a placement table and effecting printing on the medium by moving ink heads in a main scanning direction and a sub-scanning direction relative to the placement table.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A table moving mechanism comprising:
a table on which a recording medium is to be placed;
a slide apparatus to convey the table in a first direction that is horizontal; and
a lift to adjust a height of the table in an up-down direction; wherein
the slide apparatus includes:
a slide rail supporting the table and extending in the first direction;
a first base provided with the slide rail; and
a conveyor to move the table in the first direction relative to the first base along the slide rail; and
the lift includes:
raising and lowering shafts in engagement with the first base and extending in the up-down direction;
a second base on which the raising and lowering shafts stand; and
a vertical mover to move the first base relative to the second base in the up-down direction along the raising and lowering shafts.

2. The table moving mechanism according to claim 1, wherein the table includes:
a table body on which the recording medium is to be placed;
an engaging portion in engagement with the slide rail; and
a connector connecting the table body and the engaging portion to each other; wherein
the slide rail is below an upper surface of the first base;
the first base is provided with a through hole extending therethrough in the up-down direction over the slide rail; and
the connector inserted through the through hole enables the table to move in the first direction relative to the first base.

3. The table moving mechanism according to claim 1, wherein the vertical mover is provided on a lower surface of the second base.

4. The table moving mechanism according to claim 3, wherein
the vertical mover includes a leg protruding from the lower surface of the second base; and
the vertical mover is shorter in height in the up-down direction than the leg.

5. The table moving mechanism according to claim 1, wherein the raising and lowering shafts include:
at least one screw shaft rotatable around a longitudinal axis and along which the first base is to be raised and lowered; and
at least one slide shaft to guide the first base such that the first base is slidable along the at least one slide shaft; and
the at least one screw shaft is adjustable such that the longitudinal axis is parallel or substantially parallel to the at least one slide shaft.

6. The table moving mechanism according to claim 5, wherein the first base includes:
a bushing in engagement with the at least one slide shaft and fixed to the first base such that the bushing is immovable relative to the first base; and
a nut in engagement with the at least one screw shaft and fixed to the first base such that the nut is movable relative to the first base.

7. The table moving mechanism according to claim 5, wherein
the at least one screw shaft includes screw shafts provided in a pair in the first direction; and
the at least one slide shaft is provided at an intermediate position between the pair of screw shafts in the first direction.

8. The table moving mechanism according to claim 1, further comprising a side wall located outward of the first base in a second direction perpendicular or substantially perpendicular to the first direction in a plan view, the side wall extending in a longitudinal direction of the raising and lowering shafts; wherein
a predetermined gap is present between the side wall and the first base within a raising and lowering range of the first base.

9. The table moving mechanism according to claim 5, wherein
the at least one slide shaft includes slide shafts provided in a pair in a second direction perpendicular or substantially perpendicular to the first direction in a plan view, the pair of slide shafts being fixed to the first base;
the slide apparatus includes an adjuster assembly attached to one of the pair of slide shafts to adjust a position of the first base relative to the second base; and
the adjuster assembly includes:
an adjuster including a fixed portion temporarily fastenable to the first base, and an insertion hole through which one of the pair of slide shafts is slidably inserted, the adjuster being movable in the first direction relative to the first base, with the fixed portion temporarily fastened to the first base;
an adjusting piece integral with the first base, the adjusting piece being located on a first side in the first direction relative to the adjuster such that the adjusting piece faces the adjuster in the first direction;
a biasing structure in engagement with the adjuster and the first base to urge the adjuster toward the first side in the first direction; and
an adjusting screw including an extremity in abutment with one of the adjusting piece and an end portion of the adjuster located on the first side in the first direction, and a screw portion in engagement with the other one of the adjusting piece and the end portion of the adjuster located on the first side in the first direction, the adjusting screw being configured to change a distance between the adjuster and the adjusting piece in accordance with screwing or loosening of the screw portion.

10. An inkjet printer comprising:
the table moving mechanism according to claim 1;
a guide rail extending in a second direction above the table, the second direction being perpendicular or substantially perpendicular to the first direction in a plan view;
a head carriage slidable along the guide rail and movable in the second direction; and
an ink head including nozzles to discharge ink onto the recording medium placed on the table, the ink head being mounted on the head carriage.
